(19) United States
(12) Patent Application Publication
(10) Pub. No.: US 2002/0063757 A1
(43) Pub. Date: May 30, 2002

(54) Ink jet recording head and method for fabricating same

(76) Inventors: Torahiko Kanda, Tokyo (JP); Kenichi Ohno, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 10/055,911

(22) Filed: Jan. 28, 2002

Related U.S. Application Data
(62) Division of application No. 09/611,343, filed on Jul. 6, 2000.

(30) Foreign Application Priority Data
Jul. 7, 1999 (JP) 11-192471

(51) Int. Cl. B41J 2/045

(52) U.S. Cl. 347/71

(57) ABSTRACT

Adhesive agent layers are respectively formed on top surfaces of a nozzle plate, a pool plate, a supply hole plate and a pressure chamber plate. A vibration plate and the four aforementioned plates including the adhesive agent layers are stuck together. When an adhesive agent is applied to each of the four aforementioned plates, the adhesive agent with high viscosity is applied to the circumference of the hole, and an adhesive agent layer with low viscosity is applied to a region which is other than the circumference of the hole.

### FIELD OF THE INVENTION

This invention relates to an ink jet recording head and a method for fabricating the same, and especially to an ink jet recording head which draws a picture by ejecting an ink jet therefrom and a method for fabricating the same.

### BACKGROUND OF THE INVENTION

Hithereto, in an ink jet recording head of this kind, plural ink flowing pathes, each having an ink-ejecting orifice at an external end thereof, are formed on a plate in parallel with each other, and an ink jet is ejected from each ink-ejecting orifice by supplying an ink-ejecting signal to an electrical/terminal convertor provided for each ink flowing path.

In the aforementioned structure, a ceiling plate is set on partitions for separating the ink flowing pathes, and they are joined with an adhesive agent. In this case, the adhesive agent protruded from the joining portions is sometimes adheres to the ceiling plate and is cured in an arch shape behind the ink-ejecting orifice.

If the cured adhesive agent adheres to the ceiling plate of the ink flowing path behind the ink-emitting hole, a direction of an ink jet ejected from the ink-ejecting orifice is curved, which becomes a cause of unevenness in printing or twist of character-printing.

In order to overcome the aforementioned difficulty, in a technology disclosed in Japanese Patent Laid-open No. 7-195693, channels which accommodates the adhesive agent protrued from the joining portions of the partitions and the ceiling plate are provided for the upper edges of the right and left partitions behind the ink-ejecting orifice. According to this structure, protrusion of the adhesive agent into the ink-ejecting orifice or the ink-flowing path can be suppressed, and hinderance to the normal ink-ejecting characteristic caused by the cured adhesive agent can be excluded.

However, in the aforementioned conventional ink jet recording head, since the channel which accommodates the adhesive agent protruded from the joining portions of the partitions and the ceiling plate are provided for the upper edges of the right and left partitions behind the ink-ejecting orifice, the structure of the head becomes complicated, and there arises a possibility that leakage of ink occurs due to the channel.

### SUMMARY OF THE INVENTION

Accordingly, it is an object of the invention to provide an ink jet recording head which can seal an ink flowing path more securely, and improves an ink-ejecting characteristic by making the amounts of a protruded adhensive agent uniform.

It is a further object of the invention to provide a method for fabricating an ink jet recording head which seals an ink flowing path more securely, and improves an ink-ejecting characteristic by making the amounts of a protruded adhensive agent uniform.

According to the first feature of the invention, an ink jet recording head comprises:

plural plates formed of predetermined material,

plural adhesive agent layers respectively formed on surfaces of the plural plates on a predetermined side thereof,

wherein the plural plates are stuck together to form a lamination by an aid of the plural adhesive agent layers, and

Plural through holes for forming ink flowing pathes piercing through the lamination,

wherein each of the adhesive agent layers is composed of the plural through holes-surrounding parts which are respectively formed in circumferences of the plural through holes (a first region, hereinafter) and a remaining part formed in a second region which is other than the first region; and a property of an adhesive agent forming the adhesive agent layer is different from each other between the first and second regions.

According to the second feature of the invention, a method for fabricating an ink jet recording head fabricated by sticking plural plates, each having an adhesive agent layer formed on a surface thereof and plural through holes for forming ink flowing pathes, together, comprises the steps of:

applying a first adhesive agent to each of the plural plates in circumferences of the plural through holes (a first region, hereinafter), and

applying a second adhesive agent to each of the plural plates in a second region which is other than the first region,

wherein properties of the first and second adhesive agents are different from each other.

That is to say, in order to achieve the aforementioned object, in an ink jet recording head fabricated by sticking plural plates, each having an adhesive agent layer formed thereon and a hole for forming an ink flowing path, together, a property of the adhesive agent forming the adhesive agent layer is different between the circumference of the hole and a region other than the circumference of the hole.

The adhesive agent layer in the circumference of the hole is formed of an adhesive agent with high viscosity, and thereby the amount of the protruded adhesive agent can be easily controlled. On the other hand, in a region remote from the hole, the adhesive agent layer is formed of an adhesive agent which is highly fluid and satisfactory in adhesive strength and sealing property. According to this structure, an ink flowing path can be securely sealed, and the amounts of the adhesive agent protruded into the hole can be made uniform.

In the ink jet recording head according to the invention, the plural plates comprise at least

a nozzle plate provided with nozzle holes for ejecting ink,

a pool plate provided with an ink pool and first nozzle communication holes,

a supply hole plate provided with supply holes and a second nozzle communication hole,

a pressure chamber plate provided with pressure chambers, and

a vibration plate provided with an actuator for displacing the vibration plate,

wherein the nozzle holes are connected with the pressure chambers via the first and second nozzle communication holes, and the pressure chambers are connected with the ink pool via the supply holes.

Moreover, in the ink jet recording head according to the invention, the adhesive agent layer is formed of the adhesive agent with high viscosity in the circumference of the hole, and is formed of the adhesive agent with low viscosity in a region other than the same. Accordingly, in the circumference of the hole since the adhesive agent is hard to flow, the amount of the protruded adhesive agent can be easily controlled. On the other hand, in a region other than the same, since the adhesive agent has low viscosity and high fluidity, the adhesive agent is satisfactory in adhesive strength and sealing property, the ink flowing path can be securely sealed, and the amounts of the adhesive agent protruted into the hole are made uniform.

In the ink jet recording head according to another structure, the adhesive agent layer is formed of the thermo-curing adhesive agent. In the circumference of the hole, an adhesive agent with low curing temperature is used, and in a region other than the same, an adhesive agent with high curing temperature is used.

In this case, by adopting an adhesive agent with appropriate curing temperature and adequate softening property due to a rise in temperature, when the adhesive agents are cured by heating, the adhesive agent in the circumference of the hole becomes highly viscous and cured earlier that in a region other than the same.

According to the aforementioned process, since the adhesive agent in the circumference of the hole is hard to flow, and the adhesive agent in a region other than the same is highly fluid, the ink flowing path can be securely sealed, and the amounts of the adhesive agent protruded into the inside of the hole can be made uniform.

On the other hand, in the method for fabricating the ink jet recording head according to the invention, the adhesive agent layer formed in the circumference of the hole should lie within a range remote from an external edge of the hole by 50 to 100 μm. According to the aforementioned structure, the amounts of the adhesive agent protruded into the inside of the holes can be controlled easily and made uniform, and the ink flowing path can be securely sealed.

Moreover, in the other method for fabricating an ink jet recording head according to the invention, an adhesive agent which is cured by ultraviolet radiation (a UV curing property, hereinafter) is used. Before the respective plates are laminated, each adhesive agent layer formed on the plate is irradiated by ultraviolet ray in the circumference of the hole. Accordingly, the adhesive agent layer in the circumference of the hole is temporarily cured earlier than that in a region remote from the same, and thereafter the respective plates having the adhesive agent layers formed thereon are laminated.

Since an adhesion condition that the adhesive agent in the circumference of the hole is highly viscous and hard to flow, and the adhesive agent in a region other than the same is highly fluid can be realized by the aforementioned process, the ink flowing path is securely sealed and the amounts of the adhesive agent protruded into the inside of the hole can be made uniform.

Moreover, in the method for fabricating an ink jet recording head according to the invention, an adhesive agent having both thermo-curing and UV curing properties is used. Before the respective plates are laminated, the adhesive agent in the circumference of the hole or channel is irradiated by ultraviolet ray and temporarily cured earlier than the adhesive agent in a region other than the same. Thereafter, the respective plates are laminated, and the respective adhesive agent layers are permanently cured.

Since an adhesion condition that the adhesive agent in the circumference of the hole is highly viscous and hard to flow, and the adhesive agent in a region other than the same is highly fluid can be realized, the ink flowing path is securely sealed and the amounts of the adhesive agent protruded into the inside of the hole can be made uniform.

### BRIEF DESCRIPTION OF THE DRAWINGS

The invention will be explained in more detail in conjunction with appended drawings, wherein:

FIG. 1 is a disassembled perspective view of a ink jet recording head according to a preferred embodiment of the invention,

FIG. 2 is a cross-sectional view for showing a protruded adhesive agent in a communication hole of laminated plates according to an embodiment of the invention, and

FIG. 3 is a cross-sectional view for showing a method for curing an adhesive agent in the third preferred embodiment of the invention.

### DESCRIPTION OF THE PREFERRED EMBODIMENT

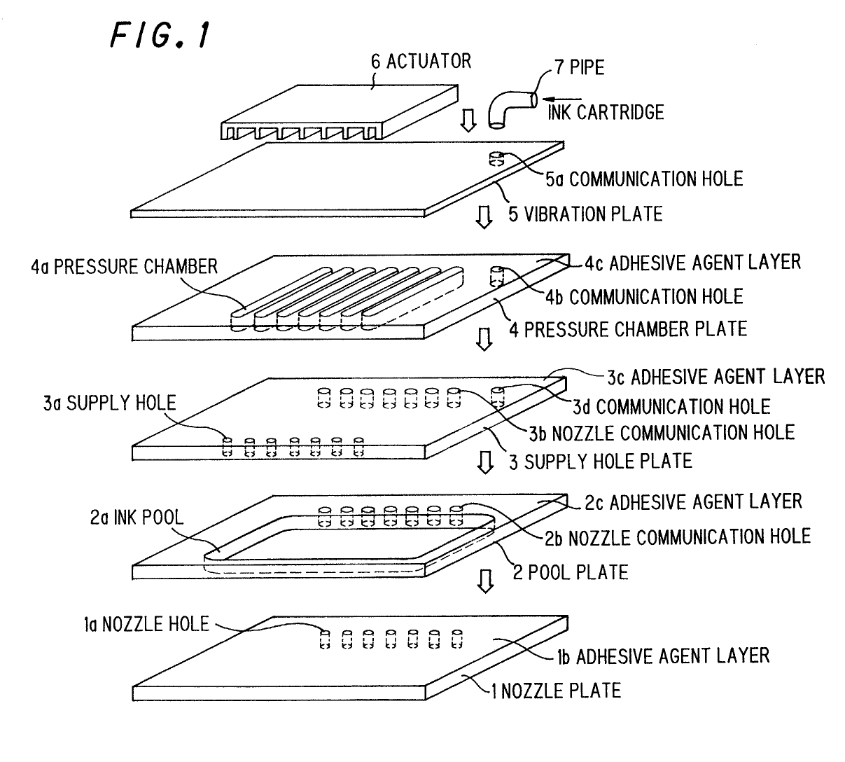

Embodiment of the invention will be explained referring to the appended drawings. FIG. 1 is a disassembled perspective view of an ink jet recording head according to the preferred embodiment of the invention. As shown in FIG. 1, in the ink jet recording head according to the first preferred embodiment of the invention, a nozzle plate 1, a pool plate 2, a supply hole plate 3, a pressure chamber plate 4 and a vibration plate 5 are successively laminated, and an actuator 6 is situated thereon.

In the aforementioned structure, the respective plates are stuck together by the aid of adhesive agent layers 1b, 2c, 3c, 4c. That is to say, the plural adhesive agent layers becomes necessary in order to laminate the plural plate.

Plural nozzle holes 1a for ejecting ink jets are formed on a nozzle plate 1. The nozzle hole 1a is communicated with a pressure chamber 4a formed on the pressure chamber plate 4 via nozzle communication holes 2b, 3b which respectively formed on the pool plate 2 and the supply hole plate 3.

The pressure chamber 4a is connected with the ink pool 2a formed on the pool plate 2 via a supply hole 3a formed on the supply hole plate 3. An ink pool 2a is connected with an ink cartridge (not shown) via communication hole 3d, 4b, 5a which are respectively formed on the supply hole plate 3, the pressure chamber plate 4 and the vibration plate 5 and a pipe 7.

Next, a fabrication process of the ink jet recording head according to the first preferred embodiment of the invention will be explained. First, the adhesive agent layer 1b is formed on a top surface of the nozzle plate 1 (a surface from which the ink jets are not ejected) by applying the adhesive agent thereto, and sticks to a bottom surface of the pool plate 2. At this time, the adhesive agent with high viscosity is applied to circumferences of portions of the top surface of the nozzle plate 1 which are opposite to the nozzle communication holes 2b and the ink pool 2a, and the adhesive agent with low viscosity is applied to a remaining area of the top surface of the nozzle plate 1.

In the first preferred embodiment of the invention, the adhesive agent with high viscosity is applied by a printing technology using a transcription pad firstly, and that with low viscosity is applied afterwards by means of the transcription pad. According to the aforementioned process, the adhesive agent in the circumferences of the holes is hard to flow, and that in the other region is highly fluid.

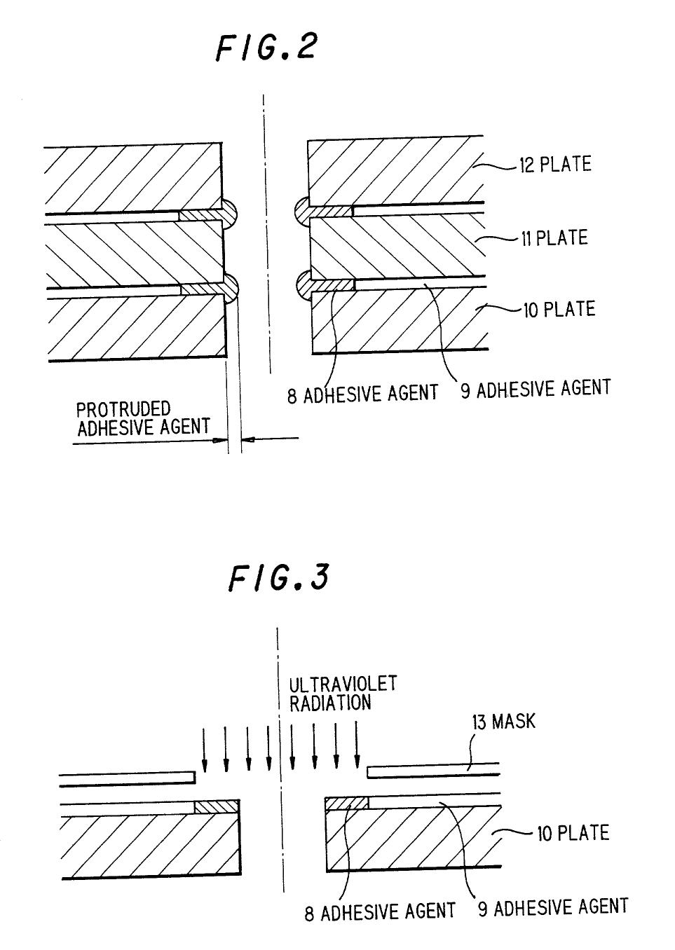

FIG. 2 is a cross-sectional view for showing the adhesive agent protruded from clearances between the laminated plates in the communication hole. Advantage of such a configuration that the adhesive agent with high viscosity is applied to the plate in the circumference of the ink flowing hole and that with low viscosity is applied thereto in a region remote from the ink flowing hole will be explained referring to FIG. 2.

As shown in FIG. 2, the adhesive agent 8 with high viscosity is applied to each plate in the circumference of the ink flowing hole, and the adhesive agent 9 with low viscosity is applied to each plate in a region other than the circumference of the ink flowing hole. Then, the plates 10 to 12 are stuck together, and the adhesive agents are cured to form a laminated configuration while pressure is applied thereto.

In this case, since the adhesive agent 8 in the circumference of the ink flowing hole is hard to flow, the adhesive agent protruded into the inside of the hole can be minimized, when pressure is applied to the laminated plates 10 to 12. On the other hand, the adhesive agent 8 with low fluidity is hard to adhere to the plates 10 to 12, an adhesive force to the plate and ink-sealing property are insufficient. From this point of view, the adhesive agent 9 with low viscosity and high fluidity is used in a region other than the circumference of the ink flowing hole. The adhesive agent 9 is easy to adhere to the plates 10 to 12, and satisfactory in adhesive strength and sealing property.

As mentioned in the above, a satisfactory adhesion condition can be obtained by applying the adhesive agents 8, 9 with different properties to the region in the circumference of the ink flowing hole and that remote from the ink flowing hole.

After the pool plate 2 and the nozzle plate 1 are stuck together, the adhensive agent layer 2c is formed on a top surface of the pool plate 2 (a surface which is not opposite to the nozzle plate 1) by applying the adhesive agent thereto, and sticks to the bottom surface of the supply hole plate 3. At this time, the adhesive agent 8 with high viscosity is applied to circumferences of portions of the top surface of the pool plate 2 which are opposite to the nozzle communication holes 3b, the communication hole 3d and the supply holes 3a, and the adhesive agent 9 with low viscosity is applied to a remaining area of the same.

Subsequently, after a bottom surface of the supply hole plate 3 and the top surface of the pool plate 2 are stuck together, the adhesive agent layer 3c is formed on a top surface of the supply hole plate 3 (a surface which is not on the side of the nozzle plate 1) by applying the adhesive agent thereto, and a bottom surface of the pressure chamber plate 4 and the top surface of the supply hole plate 3 are stuck together similarly to the aforementioned case. At this time, the adhesive agent with high viscosity is applied to circumferences of portions of the top surface of the supply hole plate 3 which are opposite to the communication hole 4b and the pressure chambers 4a, and the adhesive 9 with low viscosity is applied to a remaining area of the same.

Moreover, after the bottom surface of the pressure chamber plate 4 and the top surface of the supply hole plate 3 are stuck together, the adhesive agent layer 4c is formed on a top surface of the pressure chamber plate 4 (a surface which is not on the side of the nozzle plate 1) by applying the adhesive agent thereto, and a bottom surface of the vibration plate 5 and the top surface of the pressure chamber plate are stuck together. At this time, the adhesive agent 8 with high viscosity is applied to a circumference of a portion of the top surface of the pressures chamber plate 4 which is opposite to the communication hole 5a, and the adhesive agent 8 with low viscosity is applied to a remaining area of the same.

Thereafter, the respective adhesive agent layers are cured by adding a weight to the whole laminated plates at a top surface thereof. The ink jet recording head according to the first preferred embodiment of the invention is completed by providing the actuator 6 and the pipe 7 for the vibration plate 5.

As mentioned in the above, since the adhesive agent 8 with high viscosity is applied to the plate in the circumference of the ink flowing hole, the adhesive agent 8 is hard to flow, and the amounts of the protruded adhesive agent can be easily controlled and made uniform. On the other hand, since the adhesive agent 9 with low viscosity is applied to the plate in a region remote from the ink flowing hole and fluidity of the adhesive agent therein is high, the adhesive strength is high and the ink flowing path is securely sealed.

In the aforementioned embodiment, since the ink flowing path is securely sealed and the amounts of the protruded adhesive agent are made uniform, the ink-ejecting characteristic of the ink jet recording head is improved, and the yield rate thereof can be improved in its turn, in the aforementioned example, although the adhesive agent layers are formed on the top surfaces of the plates when the plates are stuck together, the adhesive agent layers may be formed on the bottom surfaces of the plates to form the laminated plates.

Next, the second preferred embodiment of the invention will be explained referring to FIGS. 1 and 2. Although the structure of the second preferred embodiment is almost the same as that of the first preferred embodiment, the adhesive agents 8, 9 have thermo-curing property. In the circumference of the ink flowing hole, the adhesive agent with low curing temperature is used, and in a region other than the same, the adhesive agent with high curing temperature is used.

In the second preferred embodiment, a nozzle plate 1, a pool plate 2, a supply hole plate 3, a pressure chamber plate 4 and a vibration plate 5 are successively laminated by means of adhesive agent layers 1b, 2c, 3c, 4c as shown in FIG. 1.

A point of difference in a fabrication process between the first and second preferred embodiments will be explained exemplifying the later mentioned fabrication process. That is to say, the adhesive agent layer 1b is formed on a top surface of the nozzle plate 1 (a surface which does not eject an ink jet) by applying the adhesive agent thereto, and the top surface of the nozzle plate 1 and a bottom surface of the pool plate 2 are stuck together.

In the second preferred embodiment, the thermo-curing adhesive agent 8 with low curing temperature is applied to circumferences of portions of the top surface of the nozzle plate 1 which are opposite to nozzle communication holes 2b and an ink pool 2a by a printing technology using a transcription pad, and the thermo-curing adhesive agent 9 with high curing temperature is applied to a remaining area of the same. This is a point of difference between the first and second preferred embodiments of the invention.

After the whole plates are laminated, the respective adhesive agent layers are cured by applying weight and heat thereto. When the adhesive agents are heated, both the adhesive agents 8, 9 are softened in accordance with a rise in temperature. At this time, as shown in FIG. 2, the adhesive agent 8 in the circumference of the ink flowing hole is cured in a shorter time and at lower temperature than the adhesive agent 9 in a region remote from the ink flowing hole. Accordingly, viscosity of the adhesive agent 8 becomes high earlier than the adhesive agent 9.

As mentioned in the above, since the adhesive agent 8 in the circumference of the ink flowing hole is highly viscous and hard to flow and the adhesive agent 9 in a region remote from the ink flowing hole is highly fluid, the amounts of the adhesive agent protruded into the inside of the ink flowing hole is minimized and made uniform. On the other hand, since viscosity of the adhesive agent is low and fluidity of the same is high in a region remote from the ink flowing hole, an adhesive strength of the adhesive agent is high, the ink flowing path is securely sealed, and satisfactory adhesion condition can be realized.

Subsequently, the ink jet recording head according to the second preferred embodiment can be completed by providing an actuator 6 and a pipe 7 for a vibration plate 5 situated on a top surface of the laminated plates. According to the aforementioned structure, an ink-ejecting characteristic of the ink jet recording head can be improved, and a yield rate of the products can be improved in its turn. In the second preferred embodiment of the invention, although the adhesive agent layer is formed on the top surface of the lower plate in the fabrication process, the adhesive agent layer may be formed on the bottom surface of the upper plate.

Next, the third preferred embodiment of the invention will be explained. A structure of the third preferred embodiment is similar to those of the first and second preferred embodiments. As shown in FIG. 1, a nozzle plate 1, a pool plate 2, a supply hole plate 3, a pressure chamber plate 4 and a vibration plate 5 are successively laminated by inserting adhesive agent layers 1b, 2c, 3c, 4c therebetween. A point of difference between third preferred embodiment and the other embodiments is that the adhesive agent layers 1b, 2c, 3c, 4c are formed of an adhesive agent with ultraviolet radiation curing property (UV curing property) in the third preferred embodiment.

A point of difference in a fabrication process between the third preferred embodiment and the other embodiments (the first and second preferred embodiments) will be explained exemplifying the nozzle plate 1. That is to say, the adhesive agent layer 1b is formed on a top surface of the nozzle plate 1 by applying the adhesive agent thereto, and the top surface of the nozzle plate 1 and a bottom surface of the pool plate 2 are stuck together.

FIG. 3 is a cross-sectional view for showing a method for curing the adhesive agent in the third preferred embodiment of the invention. The steps of a method for fabricating the ink jet recording head according to the third preferred embodiment of the invention will be explained referring to FIG. 3.

In the third preferred embodiment of the invention, the adhesive agent with both UV curing and thermo-curing properties is firstly applied to circumferences of portions of the top surface of the nozzle plate 1 which are opposite to nozzle communication holes 2b and an ink pool 2a.

Next, as shown FIG. 3, a mask 13 is set right above the plate 10, and the adhesive agent 8 in the circumference of the ink flowing hole is irradiated by ultraviolet ray through the mask 13. Since the adhesive agent 8 is cured by ultraviolet radiation, the adhesive agent 8 in the circumference of the ink flowing hole is temporarily cured earlier than an adhesive agent 9 applied to a region which is not irradiated by ultraviolet ray. After the whole plates are laminated similarly to the other embodiments, weight and heat is applied to the laminated plates to completely cure them.

At this time, since the adhesive agent 8 in the circumference of the ink flowing hole is highly viscous and hard to flow and the adhesive agent 9 in a region other than the circumference of the ink flowing hole is slightly viscous and easily flows, the amounts of the adhesive agent protruded into the inside of the ink flowing hole are minimized and made uniform as shown FIG. 2. On the other hand, since the adhesive agent 9 in a region other than the circumference of the ink flowing hole is slightly viscous and easily flows, the adhesive agent 9 tightly adheres to the plates and securely seals the ink flowing path, hence a satisfactory adhesion condition can be realized. The ink jet recording head according to the third preferred embodiment of the invention is completed by providing an actuator 6 and a pipe 7 for a vibration plate 5 situated on a top surface of the laminated plates.

According to the third preferred embodiment, an ink-ejecting characteristic can be improved also, and a yield rate of the products can be improved in its turn. In the third preferred embodiment, although the adhesive agent layer is formed on the top surface of the lower plate in the fabrication process, the adhesive agent layer may be formed on the bottom surface of the upper plate.

Next, the embodiments of the invention will be explained in more detail referring to the appended drawings. First, in the first preferred embodiment of the invention, a size of all the plates is 25 mm×25 mm. The thickness of the nozzle plate 1 is 75 μm, that of the pool plate 2 is 120 μm, that of the supply hole plate 3 is 75 μm, that of the pressure chamber plate 4 is 140 μm and that of the vibration plate 5 is 30 μm.

Thirty-two nozzle holes 1a are arranged in four lines on the nozzle plate 1 with the size of 25 mm×25 mm. Cross marks are provided for the respective plates in order to align them with each other. Liquid epoxy resins are used as the adhesive agents 8, 9. Viscosity of the adhesive agent 8 with high viscosity is 45000 cps, and viscosity of the adhesive agent 9 with low viscosity is 15000 cps. Thicknesses of the adhesive agent layers are both 3 μm.

First, the adhesive agent 8 with high viscosity is applied to the circumference of the ink flowing hole by a printing technology using a transcription pad. Then, the adhesive agent 9 with low viscosity is applied to a region other than the circumference of the ink flowing hole by a printing technology using a transcription pad. Thereafter, a weight of 4 kg is added to the whole laminated plates at a top surface thereof while the adhesive agents are cured.

An ink-ejecting characteristic of the ink jet recording head according to the first preferred embodiment is estimated, and the detailed internal construction thereof is surveyed by disassembling it. It is clarified that the adhesive strength of the ink jet recording head is heightened as a whole and the amounts of the adhesive agent protruded into the inside of the ink flowing hole are minimized and made uniform as an effect of such a structure that the adhesive agent with high viscosity is applied to the circumference of the ink flowing hole and the adhesive agent with low viscosity is applied to a region other than the circumference of the ink flowing hole.

In the aforementioned case, the amounts of the adhesive agent protruded into the inside of the ink flowing hole is 15 μm on an average, and the fluctuation thereof is ±8 μm. As a result, bubbles contained in ink drops are satisfactorily drawn off, and diameters of ink drops ejected from the head and ejecting speeds and directions of ink jets are respectively made uniform. Moreover, a leakage in the ink flowing path is not detected, and a yield rate of the ink recording head becomes more than 90%.

In the second preferred embodiment, the same plates as those used in the first preferred embodiment is used. The adhesive agent 8 cured at low temperature is epoxy resin, viscosity and cure starting temperature of which are respectively 45000 cps and 80° C. The adhesive agent 9 cured at high temperature is epoxy resin, viscosity and cure starting temperature of which are respectively 15000 cps and 120° C., wherein thermo-curing catalyzer is added thereto. Thicknesses of the adhesive agent layers are both 3 μm.

In the second preferred embodiment, after the adhesive agent 8 with high curing temperature is applied to the circumference of the ink flowing hole by a printing technology using a transcription pad, the adhesive agent 9 with high curing temperature is applied to a region other than the circumference of the ink flowing hole similarly to the first preferred embodiment. Thereafter, a weight of 4 kg is added to the whole laminated plates at a top surface thereof while the adhesive agents are thermo-cured. Temperature of the laminated plates rises to 120° C. from a room temperature, when 30 min has passed since thermo-cure started, and is kept to be 120° C. for 60 min.

In the ink jet recording head fabricated according to the second preferred embodiment, before viscosity of the adhesive agent 8 in the circumference of the ink flowing hole is noticeably reduced by a rise in temperature, it increases earlier than viscosity of the adhesive agent 9 in a region other than the circumference of the ink flowing hole. In addition to the aforementioned effects, the amounts of the adhesive agent protruded into the inside of the ink flowing hole can be made uniform by optimizing curing temperature of the adhesive agents 8, 9 and a heating profile at the time of cure. The amounts of the adhesive agent protruded into the inside of the ink flowing hole is 10 μm on an average, and the fluctuation thereof is ±μm. As a result, leakage of ink from the flowing path is not detected, and a yield rate of the products is more than 95% in consideration of a diameter of an ink drop ejected from the head, an ejecting speed and a direction of the ink jet.

In the third preferred embodiment, the same plates as those used in the first and second preferred embodiments is used. Epoxy resin with viscosity of 15000 cps and a cure starting temperature of 120° is used as both the adhesive agents 8, 9, and applied to a whole surface of each plate by means of a printing technology using a transcription pad, wherein thicknesses of the adhesive agent layers are both 3 μm. Moreover, only the adhesive agent 8 in the circumference of the ink flowing hole is temporarily cured by ultraviolet radiation before the respective palates are laminated. Similarly to the first and second preferred embodiments, a weight of 4 kg is added to the whole laminated plates at a top surface thereof while they are heated. A temperature of the laminate plates rises to 120° C. from a room temperature, when 30 min has passed since thermo-cure started, and kept to be 120° C. for 60 min, hence the adhesive agents are cured.

In the ink jet recording head fabricated according to the third preferred embodiment, the adhesive agent 8 becomes highly viscous by irradiating only the circumference of the ink flowing hole by ultraviolet ray. Moreover, the amounts of the adhesive agent protruded into the inside of the ink flowing hole can be made uniform by optimizing the amount of ultraviolet radiation. The amounts of the adhesive agent protruded into the inside of the ink flowing hole is 10 μm on an average, and the fluctuation thereof is ±5 μm. As a result, leakage of ink from the ink flowing path is not detected, and a yield rate of the products is more than 95% in consideration of a diameter of an ink drop ejected from the head, and ejecting speed and a direction of the ink jet.

A point of difference between the third preferred embodiment and the other embodiments is that the adhesive agent layers with different properties can be respectively formed in the circumference of the ink flowing hole and a region other than the same by using an adhesive agent of a single kind, and the fabrication process of the ink jet recording head can be simplified according to the third preferred embodiment of the invention.

Although the printing technology using the transcription pad is used in the aforementioned embodiments, other printing technologies using a stamp etc. can be applied thereto. Moreover, although a weight with a predetermine mass is set on the top surface of the laminated plates in the aforementioned embodiments, other means, such as a spring, compressed air, etc. can be adopted so long as a uniform compressive force acts on the laminated plates.

In the ink jet recording head which is fabricated by sticking the plural plates having adhesive agent layers formed on their surfaces together, the amounts of the adhesive agent protruded into the inside of the ink flowing hole can be minimized by so forming each adhesive agent layer that the adhesive agent applied to the circumference of the ink flowing hole and that applied to a region other than the circumference of the ink flowing hole have different properies, and such an optimum adhesion condition that the adhesive strength of each plate is heightened and the ink flowing path is securely sealed can be obtained.

Accordingly, since fluid resistances of against ink are made uniform and bubbles contained in ink are not collected in ink flowing paths, the fluctuations of diameters and speeds of ink jets can be suppressed, a yield rate of the ink jet recording head is improved as a result, and reduction in fabrication cost can be realized.

As mentioned in the above, in the ink jet recording head according to the invention fabricated by sticking plural plates, each having an adhesive agent layer formed on a surface thereof and a hole for forming an ink flowing path, together, since each adhesive agent layer formed in the circumference of the hole and that formed in a region other than the same are formed of the adhesive agents with different properties, each ink flowing path can be sealed more securely, the amounts of the protruded adhesive agent are made uniform, and thereby the ink ejecting characteristic can be improved.

What is claimed is:

1. According to the first feature of the invention, an ink jet recording head comprising:
plural plates formed of predetermined material,
plural adhesive agent layers respectively formed on surfaces of said plural plates on a predetermined side thereof,
wherein said plural plates are stuck together to form a lamination by an aid of said plural adhesive agent layers, and
Plural through holes for forming ink flowing pathes piercing through said lamination,
wherein each of said adhesive agent layers is composed of said plural through holes-surrounding parts which are respectively formed in circumferences of said plural through holes (a first region, hereinafter) and a remaining part formed in a second region which is other than said first region; and a property of an adhesive agent forming said adhesive agent layer is different from each other between said first and second regions.

2. The ink jet recording head as behind in claim 1, wherein:
said plural plates comprise at least
a nozzle plate provided with nozzle holes for ejecting ink,
a pool plate provided with an ink pool and first nozzle communication holes,
a supply hole plate provided with supply holes and a second nozzle communication hole,
a pressure chamber plate provided with pressure chambers, and
a vibration plate provided with an actuator for displacing said vibration plate,
wherein said nozzle holes are connected with said pressure chambers via said first and second nozzle communication holes, and said pressure chambers are connected with said ink pool via said supply holes.

3. The ink jet recording head as defined in claim 1, wherein:
said adhesive agent layer formed in said first region is formed of an adhesive agent with high viscosity, and
said adhesive agent layer formed in said second region is formed of an adhesive agent with low viscosity.

4. The ink jet recording head as defined in claim 1, wherein:
said adhesive agent layer formed in said first region is formed of an adhesive agent with low curing temperature, and
said adhesive agent layer formed in said second region is formed of an adhesive agent with high curing temperature.

5. The ink jet recording head as defined in claim 1, wherein:
said adhesive agent layer formed in said first region lies within a range remote from an outer edge of said through hole by 50 to 100 μm.

6. A method for fabricating an ink jet recording head fabricated by sticking plural plates, each having an adhesive agent layer formed on a surface thereof and plural through holes for forming ink flowing pathes, together, comprising the steps of:
applying a first adhesive agent to each of said plural plates in circumferences of said plural through holes (a first region, hereinafter), and
applying a second adhesive agent to each of said plural plates in a second region which is other than said first region,
wherein properties of said first and second adhesive agents are different from each other.

7. The method for fabricating an ink jet recording head as defined in claim 6, wherein:
said plural plates comprise at least
a nozzle plate provided with nozzle holes for ejecting ink,
a pool plate provided with an ink pool and first nozzle communication holes,
a supply hole plate provided with supply holes and a second nozzle communication hole,
a pressure chamber plate provided with pressure chambers, and
a variation plate provided with an actuator for displacing said vibration plate,
wherein said nozzle holes are connected with said pressure chambers via said first and second communication holes, and said pressure chambers are connected with said ink pool via said supply holes.

8. The method for fabricating an ink jet recording head as defined in claim 6, wherein:
said adhesive agent layer formed in said first region is formed of an adhesive agent with high viscosity, and
said adhesive agent layer formed in said second region is formed of an adhesive agent with low viscosity.

9. The method for fabricating an ink jet recording head as defined in claim 6, wherein:
said adhesive agent layer formed in said first region is formed of an adhesive agent with low curing temperature, and
said adhesive agent layer formed in said second region is formed of an adhesive agent with high curing temperature.

10. The method for fabricating an ink jet recording head as defined in claim 6, wherein:
said adhesive agent layer formed in said first region lies within a range remote from an outer edge of said through hole by 50 to 100 μm.

11. The method for fabricating an ink jet recording head as defined in claim 6, wherein:
said adhesive agent layer is formed of an adhesive agent with ultraviolet radiation curing property (UV curing property, hereinafter), and
said plural plates are laminated after said each adhesive agent layer is irradiated by ultraviolet ray in said first region to be temporarily cured earlier that in said second region.

12. The method for fabricating an ink jet recording head as defined in claim 11, wherein:
said adhesive agent forming said adhesive agent layer has both thermo and UV curing properties, and is permanently cured by a thermo-curing process conducted after said plural plates are laminated.
